(19) United States
(12) Patent Application Publication
(10) Pub. No.: US 2011/0093477 A1
(43) Pub. Date: Apr. 21, 2011

(54) METHOD FOR ESTIMATION OF ORDER-BASED STATISTICS ON SLOWLY CHANGING DISTRIBUTIONS

(75) Inventor: Bruce E. Aldridge, Oceanside, CA (US)

(73) Assignee: TERADATA US, INC., Miamisburg, OH (US)

(21) Appl. No.: 12/703,493

(22) Filed: Feb. 10, 2010

Related U.S. Application Data
(60) Provisional application No. 61/253,391, filed on Oct. 20, 2009.

(51) Int. Cl. G06F 17/30; G06F 7/22

(52) U.S. Cl. 707/752; 703/2; 707/607; 707/E17.104; 707/E17.045

(57) ABSTRACT

A computer-implemented method for estimation of order-based statistics on slowly changing distributions of data stored on a computer. An initial set of data is converted to an initial histogram based representation of the data set's distribution. New or removed data is converted into a new histogram separate from the initial histogram. The new histogram is combined with the initial histogram to build a combined histogram. Percentiles and order-based statistics are estimated from the combined histogram to provide analysis of a combination of the initial set of data combined with the new or removed data.

### CROSS REFERENCE TO RELATED APPLICATIONS

This application claims the benefit under 35 U.S.C. Section 119(e) of co-pending and commonly-assigned U.S. Provisional Patent Application Ser. No. 61/253,391, filed on Oct. 20, 2009, by Bruce E. Aldridge, entitled “Method for Estimation of Order-Based Statistics on Slowly Changing Distributions,” attorneys' docket number 20153 (30145.470-US-P1), which application is incorporated by reference herein.

This application is related to the following co-pending and commonly assigned patent applications:

U.S. Utility patent application Ser. No. 10/742,966, filed on Aug. 9, 2004, by Bruce E. Aldridge and Rangarajan S. Thirumpoondi, entitled “System and Method for Tuning a Segmented Model Representing Product Flow Through a Supply Chain or Manufacturing Process,” attorneys' docket number 11408;

U.S. Utility patent application Ser. No. 10/254,234, filed on Sep. 25, 2002, by Bruce E. Aldridge and Rangarajan S. Thirumpoondi; entitled “Analyzing a Supply Chain Based on a Segmented Representation of the Supply Chain,” attorneys' docket number 10,998.10; and

U.S. Utility patent application Ser. No. 11/495,388, filed on Jul. 28, 2006, by Bruce E. Aldridge, entitled “Process Sequence Modeling using Histogram Analytics,” attorneys' docket number 12417;

which applications are incorporated by reference herein.

### BACKGROUND OF THE INVENTION

1. Field of the Invention

This invention relates to the estimation of order-based statistics on slowly changing distributions.

2. Description of Related Art

Calculation of order-based statistics such as median, quartiles and percentiles (a.k.a. quantiles) generally requires sorting the entire data set, assigning percentiles to the sorted data and estimating the desired percentile from the sorted data.

When the data set of interest changes over time through the addition or removal of data, each change requires a complete re-read and re-analysis of the entire data set to estimate the new percentile values resulting from the new data. For large data sets, this can require considerable time when only a small amount of new data is added or removed.

What is needed in the art is an improved method that avoids reading the entire data set every time a change is made. Typically, this will be most useful when a small change in an existing data set is made, or a slowly changing distribution of data. The present invention satisfies that need.

### SUMMARY OF THE INVENTION

The present invention discloses a computer-implemented method, apparatus and article of manufacture for estimation of order-based statistics on slowly changing distributions of data stored on a computer. An initial set of data is converted to an initial histogram based representation of the data set's distribution. New or removed data is converted into a new histogram separate from the initial histogram. The new histogram is combined with the initial histogram to build a combined histogram. Percentiles and order-based statistics are estimated from the combined histogram to provide analysis of a combination of the initial set of data combined with the new or removed data.

### BRIEF DESCRIPTION OF THE DRAWINGS

Referring now to the drawings in which like reference numbers represent corresponding parts throughout:

FIG. 1 illustrates an exemplary hardware and software environment according to the preferred embodiment of the present invention.

FIG. 2 is a histogram of group 1 data and cumulative percent plot.

FIG. 3a is a histogram of group 2 data, FIG. 3b is a histogram of group 1 data, and FIG. 3c is a histogram of combined group 1 and 2 data.

FIG. 4a is a histogram of group 1 and 2 data, FIG. 4b is a histogram of group 3 data, and FIG. 4c is a histogram of combined group 1, 2 and 3 data.

FIGS. 5a, 5b, 5c and 5d are illustrations of the overlap between input and output bins where the shaded portions represent the fraction of the percentage added from the input bin.

FIG. 6 is a flow chart illustrating the logic of the preferred embodiment of the present invention.

### DETAILED DESCRIPTION OF THE PREFERRED EMBODIMENT

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

Overview

The present invention introduces a novel method for estimation of order-based statistics on slowly changing distributions, according to the present invention.

Hardware and Software Environment

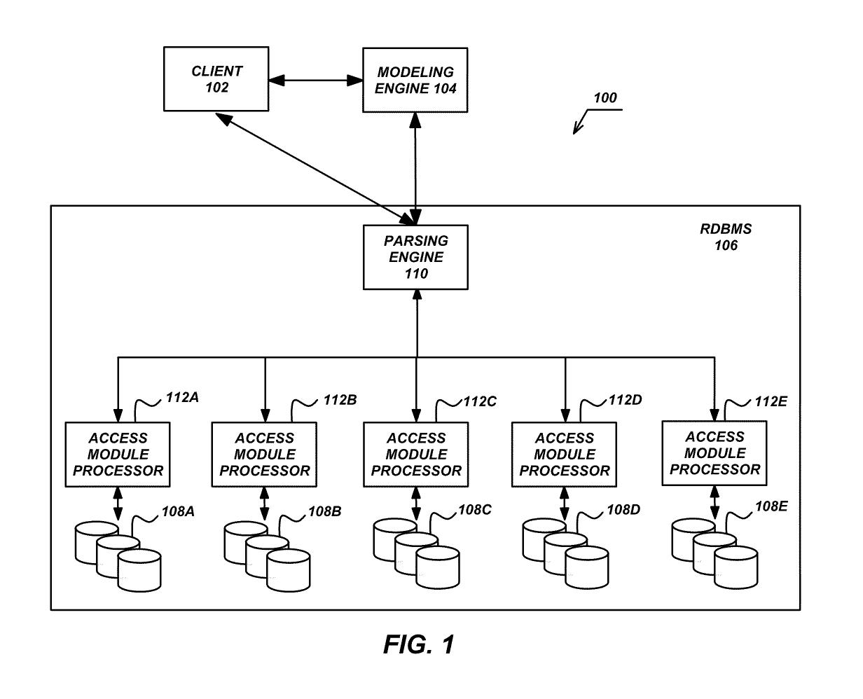

FIG. 1 illustrates an exemplary hardware and software environment according to the preferred embodiment of the present invention. In the exemplary environment, a computer system 100 implements a Modeling Engine Framework in a three-tier client-server architecture, wherein the first or client tier provides a Client 102 that provides an operator interface to the system 100, the second or middle tier provides a Modeling Engine 104 for performing functions as described later in this application, and the third or server tier comprises a Relational DataBase Management System (RDBMS) 106 that stores data and metadata in a relational database 108A-E. The first, second, and third tiers may be implemented in separate machines, or may be implemented as separate or related processes in a single machine. Moreover, alternative embodiments are not restricted to a 3-tier system, as the present invention may be implemented on all manner of computer systems.

In the preferred embodiment, the RDBMS 106 includes at least one Parsing Engine (PE) 110 and one or more Access Module Processors (AMPs) 112A-112E storing the relational database 108. The Parsing Engine 110 and Access Module Processors 112 may be implemented in separate machines, or may be implemented as separate or related processes in a single machine. The RDBMS 106 used in the preferred embodiment comprises the Teradata® RDBMS sold by Teradata Corporation, the assignee of the present invention, although other DBMS's could be used.

Generally, the Client 102 includes a graphical user interface (GUI) for users of the system 100, wherein requests are transmitted to the Modeling Engine 104 and/or the RDBMS 106, and responses are received therefrom. In response to the requests, the Modeling Engine 104 performs the functions and steps described below, including formulating queries for the RDBMS 106 and processing data retrieved from the RDBMS 106. Moreover, the results from the functions and steps performed by the Modeling Engine 104 may be provided directly to the Client 102 or may be provided to the RDBMS 106 for storing into the relational database 108. Once stored in the relational database 108, the results from the functions and steps performed by the Modeling Engine 104 may be independently retrieved from the RDBMS 106 by the Client 102.

Note that the Client 102, the Modeling Engine 104, and the RDBMS 106 may be implemented in separate machines, or may be implemented as separate or related processes in a single machine. For example, the system may comprise a two-tier client-server architecture, wherein the client tier includes both the Client 102 and the Modeling Engine 104.

Moreover, in the preferred embodiment, the system 100 may use any number of different parallelism mechanisms to take advantage of the parallelism offered by the multiple tier architecture, the client-server structure of the Client 102, Modeling Engine 104, and RDBMS 106, and the multiple Access Module Processors 112 of the RDBMS 106. Further, data within the relational database 108 may be partitioned across multiple data storage devices to provide additional parallelism.

Generally, the Client 102, Modeling Engine 104, RDBMS 106, Parsing Engine 110, and/or Access Module Processors 112A-112E comprise logic and/or data tangibly embodied in and/or accessible from a device, media, carrier, or signal, such as RAM, ROM, one or more of the data storage devices, and/or a remote system or device communicating with the computer system 100 via one or more data communications devices.

However, those skilled in the art will recognize that the exemplary environment illustrated in FIG. 1 is not intended to limit the present invention. Indeed, those skilled in the art will recognize that other alternative environments may be used without departing from the scope of the present invention. In addition, it should be understood that the present invention may also apply to components other than those disclosed herein.

General Description

To accomplish a method for estimation of order-based statistics on slowly changing distributions according to the present invention, the Modeling Engine Framework performs the following functions and steps:

Step 1): Convert the initial data set to an initial histogram based representation of the distribution. The number of bins in the histogram should be scaled for the desired accuracy, e.g., 0.5% accuracy in estimations should utilize 200 bins. Alternatively, methods also exist for variable width histograms, i.e., instead of constant width, which determine bin size by constant or functionally determined bin counts.

From the initial histogram, estimate percentiles by interpolation between the bin beginning and bin end. For large data sets, the estimation will be considerably faster because of the reduced number of bins (e.g., 200 bins vs. potentially millions of rows of data). Thus, repetitive analysis of quantiles can be made at different times on the data set requiring only a single analysis.

Step 2): As new data arrives, or data is removed, convert the set of new or removed data into a new histogram.

Step 3): Combine the new histogram with the initial histogram to build a combined histogram representative of the combined data. For addition of data, the histograms are added; whereas for removal, the corresponding probabilities are subtracted. Histogram combination is performed using a method described in co-pending and commonly-assigned U.S. Utility patent application Ser. No. 11/495,388, filed on Jul. 28, 2006, by Bruce E. Aldridge, entitled “Process Sequence Modeling using Histogram Analytics,” attorneys' docket number 12417, which is incorporated by reference herein. Specifically, histogram combination is essentially computed by determining the weighted contribution of each input histogram to the combined output.

Because the histograms can be much smaller and more compact than the data set, the computation of a combined histogram is extremely fast.

Step 4): Estimate the percentiles and order based statistics from the combined histogram to provide analysis of the changed data.

Step 5): Store the histogram(s) and the calculated value(s) in the relational database 108A-E managed by the RDBMS 106 for later retrieval, further updates, additional calculations, etc., as well as for presentation to one or more users of the Modeling Engine Framework.

Examples of these functions and steps are provided below.

Advantages and Benefits

The primary advantage of the solution afforded by this invention is improved performance while yielding acceptable methods of accuracy. Existing methods require long analysis times and rely on interpolation between data points, when even a small amount of new data is loaded. Conversion to histograms and combining new and old data can provide orders of magnitude improvements in analysis times while yielding acceptable errors.

Other benefits include:
the visualization of the data through histograms,
repetitive analysis of the distribution does not require repetitive sorting of the data, and
more compact storage of histograms relative to large data sets.

### EXAMPLES

The following examples illustrate one embodiment of the present invention.

Statistics of Slowly Changing Large Data Sets

A data set of 1,000,000 values were generated in three groups as follows:
Group 1: 500,000 rows random normal distribution with mean 5 and standard deviation (stdev) 1.
Group 2: 300,000 rows random normal distribution with mean 7 and stdev 0.8.
Group 3: 200,000 rows random normal distribution with mean 9 and stdev 1.5.

Assume that all three groups of data belong to the same data set (i.e., have the same key fields), but are acquired at different times in the order given above (group 1, then combine group 2 data to group 1, and finally, combine group 3 data to the combined group 1 and 2). Further, assume that it is desired to analyze all available data as soon as it is acquired. In other words, the analysis consists of order based statistics on 500,000 rows, followed by analysis of 800,000 rows, followed by analysis of 1,000,000 rows.

This example will deal with computation percentiles, specifically, the 0.1%, 0.2%, 0.4%, 1%, 2.5%, 5%, 10%, 25%, 50%, 75%, 90%, 95%, 97.5%, 99%, 99.6%, 99.8% and the 99.9%-iles.

Analysis of Group 1: 500,000 Rows

Calculate from the Detailed Data.

The percentiles can be directly computed from the detailed data by using SQL as described below in the section entitled “Calculation of quantiles from detailed data.” The results applied to the first group of 500,000 are shown in Table 1 in the column entitled “Detailed Data Value.” The percentiles are computed through interpolation of the data between the nearest actual percentiles as determined by (i−1)/(n−1), where i is the sorted row number and n is the total number in the group. Note that this is only one of several accepted methods for estimating percentiles, which could be used in other embodiments.

This calculation required 3.5 minutes when executed on an exemplary system 100, wherein the RDBMS 106 of the exemplary system 100 comprised a demo version of Teradata V2R6.2. The calculation times referred to hereinafter resulted from calculations performed by this exemplary system 100.

TABLE 1
Comparison of detailed data (500,000 points)
and histogram approximations.

| | Detail Data | Estimate from | Absolute |
|---|---|---|---|
| Percentile | Value (3.5 min) | histogram (18 sec) | Error |
| 0.1% | 1.8844 | 1.8825 | 0.101% |
| 0.2% | 2.1022 | 2.1017 | 0.024% |
| 0.4% | 2.3315 | 2.3314 | 0.004% |
| 1.0% | 2.6649 | 2.665 | 0.004% |
| 2.5% | 3.0393 | 3.0386 | 0.023% |
| 5.0% | 3.3495 | 3.3494 | 0.003% |
| 10.0% | 3.717 | 3.7171 | 0.003% |
| 25.0% | 4.3253 | 4.3247 | 0.014% |
| 50.0% | 4.9953 | 4.9952 | 0.002% |
| 75.0% | 5.6721 | 5.672 | 0.002% |
| 90.0% | 6.2814 | 6.2814 | 0.000% |
| 95.0% | 6.6507 | 6.6508 | 0.002% |
| 97.5% | 6.9637 | 6.9636 | 0.001% |
| 99.0% | 7.3327 | 7.332 | 0.010% |
| 99.6% | 7.6457 | 7.646 | 0.004% |
| 99.8% | 7.8586 | 7.8634 | 0.061% |
| 99.9% | 8.0752 | 8.0778 | 0.032% |
| Average Error | | | 0.017% |

Conversion to a Histogram

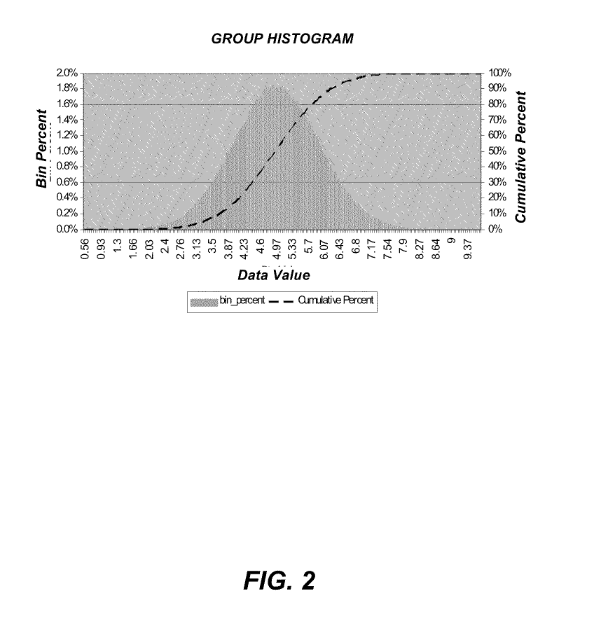

Frequently, data distributions are converted to histograms to aid in the visualization of the data. FIG. 2 shows a histogram representation of the group 1 data and cumulative percent plot constructed through a custom user defined function (UDF) comprised of SQL statements executed by the RDBMS 106. The histogram has 200 bins and the cumulative percentage is also shown as a dashed line.

Construction of the histogram required approximately 18 seconds.

Different algorithms may be used to build the histogram in the UDF. One algorithm divides the bins into equal widths and counts the data points within each bin. Another algorithm constructs the cumulative distribution function and interpolates bin end/beginning values for more sparse data sets. Both algorithms allow for a specification to remove outliers. Moreover, other embodiments may use other algorithms.

Estimation of Statistics from a Histogram

The percentiles can be estimated from the histogram by interpolation between bins using the cumulative percentage (see FIG. 2). The custom UDF was used to extract the percentiles from the histogram of built for group 1 data. The results are shown in Table 1 under the column “Estimate from histogram.” Note the average absolute error of 0.017%, which will correlate to the number of bins in the histogram (200 bins implies a max error of 0.05%). (The max error is for “well behaved” data. For distributions of sparse data or extreme outliers additional assumptions must be made or the error could be excessive.)

This UDF executed in less than 1 second.

Therefore, computing the analytics from the raw data required 3 minutes 30 seconds, whereas converting the data to a histogram and estimating the quantiles required a net time of approximately 19 seconds with an average error of 0.017%. (It should be noted that performance improvements of the calculations on the detailed data were not attempted as the primary focus of this example is to evaluate groups that change over time with histograms.)

Analysis of Group 1 and 2 Data (Combined)

Generation of Statistics on Detailed Data

With the addition of group 2 data (300,000 rows), the analysis set grows to 800,000 data elements. This can be directly analyzed with the same SQL as before with the results shown in Table 2.

This analysis required 7 minutes, 40 seconds.

TABLE 2
Comparison of Group 1 and 2 statistics.
Detailed analysis vs. histogram combinations

| | | Histogram | |
|---|---|---|---|
| | Detail Data | Combination | |
| Percentile | (7.67 min) | (13 sec) | Error |
| 0.1% | 2.0364 | 2.0317 | 0.231% |
| 0.2% | 2.2554 | 2.2555 | 0.004% |
| 0.4% | 2.5021 | 2.501 | 0.044% |
| 1.0% | 2.8516 | 2.8516 | 0.000% |
| 2.5% | 3.246 | 3.245 | 0.031% |
| 5.0% | 3.5933 | 3.5928 | 0.014% |
| 10.0% | 4.0022 | 4.0022 | 0.000% |
| 25.0% | 4.74 | 4.7398 | 0.004% |
| 50.0% | 5.7259 | 5.7259 | 0.000% |
| 75.0% | 6.7894 | 6.7896 | 0.003% |
| 90.0% | 7.5228 | 7.5231 | 0.004% |
| 95.0% | 7.8995 | 7.9005 | 0.013% |
| 97.5% | 8.2032 | 8.204 | 0.010% |
| 99.0% | 8.5455 | 8.5464 | 0.011% |
| 99.6% | 8.8417 | 8.8438 | 0.024% |
| 99.8% | 9.0521 | 9.0528 | 0.008% |
| 99.9% | 9.2412 | 9.245 | 0.041% |
| Average Error | | | 0.026% |

Combining Histograms

As additional data is made available, the use of histograms can improve performance for analysis of the combined data. This is illustrated as follows:

1. Build histogram for group 2.

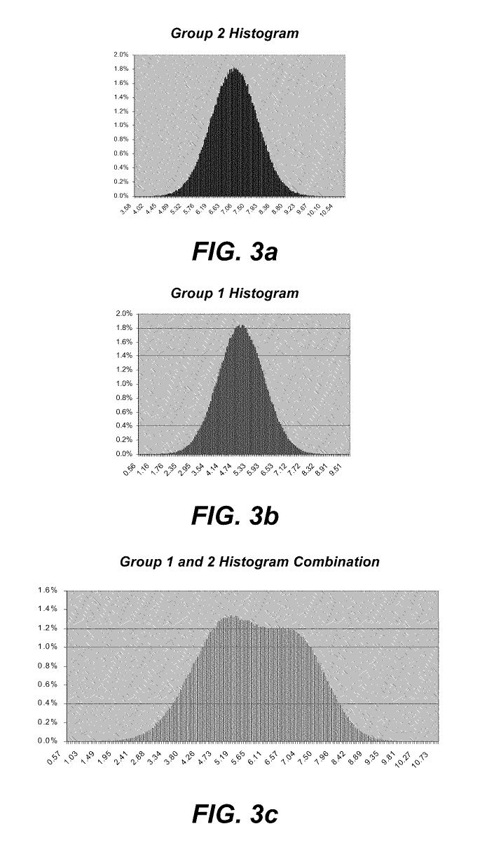

Equivalent SQL can be executed to build a histogram for only the data in the second group (300,000). Because of the smaller size, this histogram was built in approximately 12 seconds. The result is illustrated in FIG. 3a.

2. Combine histogram group 2 with histogram group 1.

Since a histogram already exists for group 1, the two histograms can be combined by comparing probabilities, bins and relative weights (e.g., bin counts), and building a third histogram representative of the combination. The section below entitled “Combination of histograms” discusses the method of histogram combination.

A special UDF was written for the calculation and histogram group 1 was combined with histogram group 2 by noting the relative weights as 0.625 (⅝ of data) and 0.375 (⅜). The generation of the resulting histogram took approximately 1 second and is illustrated in FIG. 3b.

3. Compute estimated percentiles from result histogram.

Using the same estimation as in the previous example, the percentiles can be estimated from the built combination histogram. FIG. 3c shows the combination histogram.

This calculation required less than 1 second.

Comparison of Results

The results of determining percentiles from the raw data and the combined histograms are shown in Table 2. Note that the net time for the histogram approach is effectively the time required to build the group 2 histogram, or 13 seconds vs. 7 minutes and 41 seconds for the complete detailed calculation. Also note the average error of 0.026%, comparable to the error in Table 1.

Therefore, computing the analytics from the raw data required 7 minutes 41 seconds, whereas converting the new data to a histogram and combining with the existing histogram for estimating the quantiles required a net time of approximately 13 seconds with an average error of 0.026%.

Analysis of Groups 1, 2 and 3

When the group 3 data is made available, the total number of data points for analysis is 1,000,000. As before, the entire set of detailed data can be analyzed with similar SQL, and for the determination of quantiles, this is typically required.

Table 3 shows the results of the detailed analysis, requiring approximately 9 minutes.

TABLE 3
Comparison of detailed data and double histogram merge.
Also shown are results from histogram constructed directly
from data.

| | | Histogram | | Histogram | |
|---|---|---|---|---|---|
| | Detail Data | Combination | | from data | |
| Percentile | (9 minutes) | (8 seconds) | Error | (1 minute) | Error |
| 0.1% | 2.102 | 2.0982 | 0.181% | 2.0992 | 0.133% |
| 0.2% | 2.3313 | 2.3297 | 0.069% | 2.3302 | 0.047% |
| 0.4% | 2.5826 | 2.5795 | 0.120% | 2.5798 | 0.108% |
| 1.0% | 2.9455 | 2.9444 | 0.037% | 2.9454 | 0.003% |
| 2.5% | 3.3492 | 3.3481 | 0.033% | 3.3489 | 0.009% |
| 5.0% | 3.7163 | 3.7149 | 0.038% | 3.7154 | 0.024% |
| 10.0% | 4.1537 | 4.1534 | 0.007% | 4.1534 | 0.007% |
| 25.0% | 4.9826 | 4.9823 | 0.006% | 4.9824 | 0.004% |
| 50.0% | 6.2193 | 6.2192 | 0.002% | 6.2191 | 0.003% |
| 75.0% | 7.5074 | 7.5075 | 0.001% | 7.5075 | 0.001% |
| 90.0% | 9.0311 | 9.0317 | 0.007% | 9.0313 | 0.002% |
| 95.0% | 10.0154 | 10.0158 | 0.004% | 10.0157 | 0.003% |
| 97.5% | 10.7298 | 10.7297 | 0.001% | 10.7306 | 0.007% |
| 99.0% | 11.4741 | 11.4746 | 0.004% | 11.475 | 0.008% |
| 99.6% | 12.0777 | 12.0801 | 0.020% | 12.0795 | 0.015% |
| 99.8% | 12.494 | 12.4937 | 0.002% | 12.4941 | 0.001% |
| 99.9% | 12.8568 | 12.8573 | 0.004% | 12.8582 | 0.011% |
| average | | | 0.032% | | 0.023% |

Solution with Histogram Combinations

Generation of a single histogram representing only the new data and then combining this histogram with the existing data can considerably speed up the analysis of the group.

As in the previous example, this is done in three steps:

1. Build histogram for group 3.

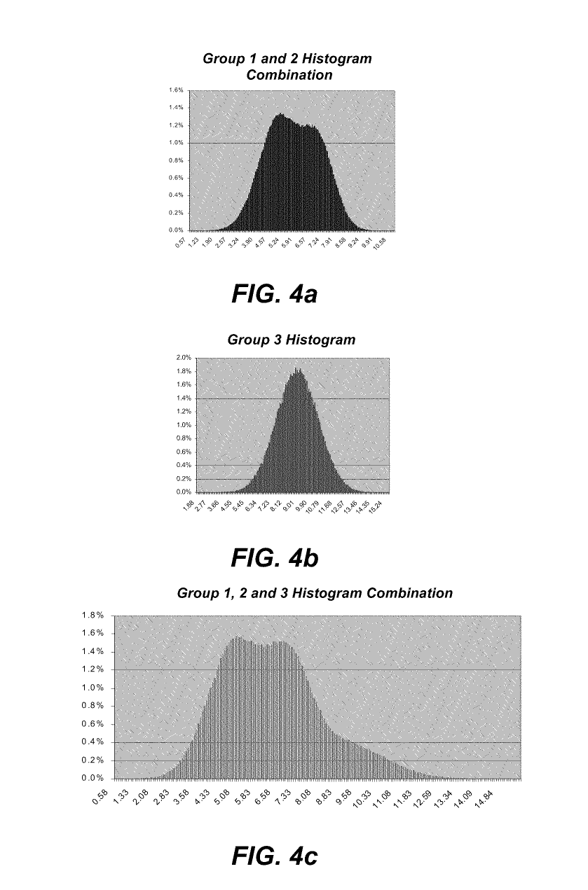

Assume a histogram already exists for the aggregate of groups 1 and 2. This is shown in FIG. 4a. The histogram representative of the new data (200,000 rows) is built and requires approximately 7 seconds. The result is illustrated in FIG. 4b.

2. Combine group 3 with the aggregate histogram of groups 1 and 2.

Since a histogram already exists for the aggregate of groups 1 and 2, the new data histogram can be combined as before (see the section below entitled “Combination of histograms”). The resulting histogram is shown in FIG. 4c and required approximately 1 second to build.

In this case, the weights are 0.8 for the groups 1 and 2 histogram (which are 8/10ths of the total data) and 0.2 for the group 3 histogram (which is 2/10ths of the total data).

3. Compute estimated percentiles from result histogram.

The quantiles are then estimated from the composite histogram representing all three data sets (see Table 3).

Also included in Table 3 is an equivalent histogram generated from all three sets for reference. Evaluation of Table 3 shows the error has increased as expected with multiple histogram combinations.

Therefore, computing the analytics from the raw data required 9 minutes, whereas converting the new data to a histogram and combining with the existing histogram for estimating the quantiles required a net time of approximately 8 seconds with an average error of 0.032%.

### SUMMARY

For applications requiring percentile (or quantile) based statistics, the conversion of the data to a histogram provides an alternative method for rapid calculations without requiring re-reading all of the data. Specifically, when new data becomes available, a method for combining histograms of the new data with the existing group provides a quick means for computing statistics.

Table 4 shows the net time and error for calculations when two additional groups of data are made available.

TABLE 4
Time and approximate accuracy of histogram approximations

| | Calculation Time | | |
|---|---|---|---|
| | Detailed | | Approximate |
| | data | Histogram | Error |
| 500k rows | 3.5 min | 18 seconds | 0.017% |
| 500k + 300k = 800k rows | 7.67 min | 13 seconds | 0.026% |
| 500k + 300k + 200k = 1E6 rows | 9 min | 8 seconds | 0.032% |

Calculation of Quantiles from Detailed Data

The SQL below computes the equivalent percentiles by ordering the data (column data_val in table large_sample). Each data value is assigned a percentile equal to (i−1)/(n−1) where i is the row number and n is the total number of rows in the group.

The actual percentile is then found by interpolation between the two bounding data elements.

with tmp_pctile (row_nmbr, data_val, denom, pctile, pct_diff) as (

select a.row_nmbr, a.data_val

, cast(b.cnt−1 as float) as denom
, cast( −1.0 + a.row_nmbr as float)

/ denom as pctile

, 1.0/ denom as pct_diff

from (
select data_val, row_number( ) over (order by data_val) as row_nmbr
from large_sample
where idx =?idx
) a, (
select count(*) as cnt from large_sample
where idx=?idx
) b )
select x.pctile
, a.data_val + (x.pctile − a.pctile)*(b.data_val−a.data_val)/a.pct_diff

as qtile

from tmp_pctile a, tmp_pctile b
, pctiles x
where a.row_nmbr = (b.row_nmbr − 1)
and x.pctile between a.pctile and (a.pctile + a.pct_diff) ;

Combination of Histograms

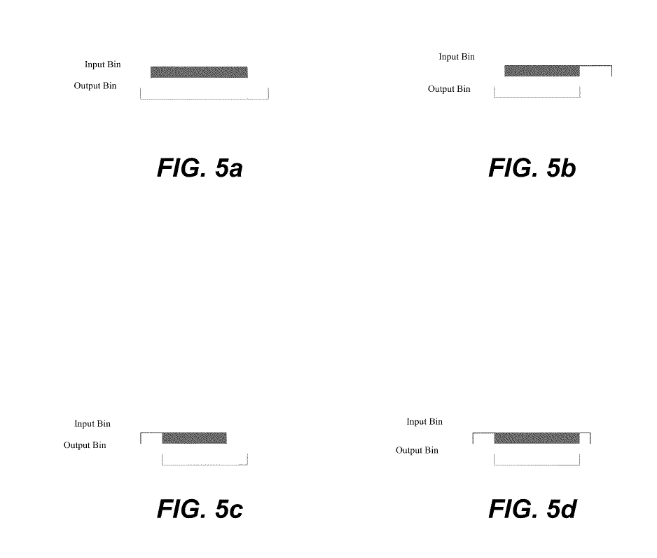

When it is necessary to combine two histograms, the following steps are taken:
Determine the minimum of both histograms. This is the new minimum of the resulting (output) histogram.
Determine the maximum of both histograms. This is the new maximum of the output histogram.
Build an empty output histogram by dividing the range (minimum to maximum) into equal sized bins as specified by the user (e.g., 200 bins).
Multiply the bin_percentage values of each input histogram by the relative weight of the data representative of that histogram. For example, if one histogram contains 60% of the data, all the percentages for that histogram are multiplied by 0.6.
For each bin in the output histogram distribute the probabilities (i.e., re-bin) proportionately to the amount of overlap of the input bins. Note that there are typically four possibilities for overlap as described below:
   Input bin totally contained within output bin. In this case, the entire bin percent from the input bin is added (cumulatively) to the output bin. This is shown in FIG. 5a.
   Input bin starts within output bin, but ends one or more bins above. In this case, the shaded fraction of the Input bin is added to the output bin. This is shown in FIG. 5b.
   Input bin starts before output bin but ends within output bin. In this case, the shaded fraction of the input bin is added to the output bin. This is shown in FIG. 5c.
   Input bin spans output bin. In this case, the shaded fraction corresponding to the width of the output bin is added. This is shown in FIG. 5d.

Note that the comparisons are always left based (i.e., <= or >= when referring to a left edge of a bin). This avoids duplicate counting when an input bin end aligns exactly with an output bin.
Compare the resulting bins to the min_percentage specified by the user or application, and remove edge bins below the min_percentage. (Removal of low probability outlier bins is a user option that keeps the outliers from dominating bin widths.) Renormalize if necessary.

Logic of the Preferred Embodiment

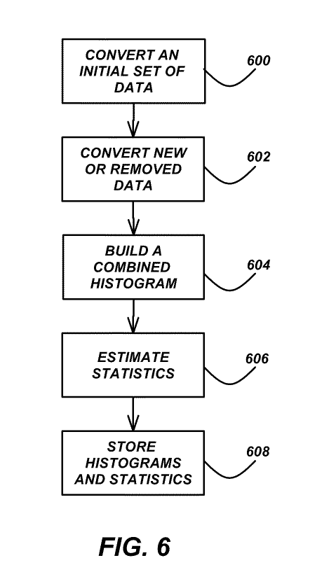

FIG. 6 is a flow chart illustrating the logic performed by the system 100 in the preferred embodiment of the present invention. Specifically, the logic comprises a computer-implemented method for estimation of order-based statistics on slowly changing distributions in data stored on the system 100. This logic is typically embodied in the Modeling Engine Framework performed by the system 100.

Those skilled in the art will recognize that this logic is provided for illustrative purposes only and that different logic may be used to accomplish the same results. Moreover, the various aspects of the logic may be performed by one or more of the Client 102, Modeling Engine 104, RDBMS 106, Parsing Engine 110 and/or Access Module Processors 112A-112E. 11.

Block 600 represents converting an initial set of data to an initial histogram based representation of the data set's distribution. In this Block, a number of bins in the initial or new histogram are scaled for a desired accuracy. Moreover, from the initial histogram, percentiles are estimated by interpolation between a bin beginning and a bin end.

Block 602 represents converting new or removed data into a new histogram separate from the initial histogram. This Block may be performed as data is added to the new histogram or as data is removed from the initial histogram.

Block 604 represents combining the new histogram with the initial histogram to build a combined histogram. In one embodiment, the combined histogram is representative of combined data from the new histogram and the initial histogram. In this Block, for an addition of data, the new histograms is added to the initial histogram; whereas, for a removal of data, the new histogram is subtracted from the initial histogram. In either instance, the combined histogram is computed by determining a weighted contribution of the new histogram and the initial histogram to the combined histogram.

Block 606 represents estimating percentiles and order-based statistics from the combined histogram to provide analysis of a combination of the initial set of data combined with the new or removed data.

Block 608 represents the initial, new and/or combined histogram(s) and calculated value(s) comprised of the estimated percentiles and order-based statistics being stored in the relational database 108A-E managed by the RDBMS 106 for later retrieval, further updates, and additional calculations, etc., as well as for presentation to one or more users of the Modeling Engine Framework.

### CONCLUSION

This concludes the description of the preferred embodiment of the invention. The following paragraphs describe some alternative embodiments for accomplishing the same invention.

In one alternative embodiment, any type of computer or configuration of computers could be used to implement the present invention. In addition, any database management system, analytical application, or other computer program that performs similar functions could be used with the present invention.

In another alternative embodiment, other statistical estimation methods or algorithms could be used. For example, this embodiment set forth above dealt with percentiles, but other algorithms could be used, including algorithms for extraction of: percentiles (quantiles) including median, quartiles and inter quartile range; min/max/range; and mean, standard deviation/variance, skewness and kurtosis.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for estimation of order-based statistics on slowly changing distributions in data stored on a computer, comprising:
(a) converting, in the computer, an initial set of data to an initial histogram based representation of the data set's distribution;
(b) converting, in the computer, new or removed data into a new histogram separate from the initial histogram;
(c) combining, in the computer, the new histogram with the initial histogram to build a combined histogram; and
(d) estimating, in the computer, percentiles and order-based statistics from the combined histogram to provide analysis of a combination of the initial set of data combined with the new or removed data.

2. The method of claim 1, wherein a number of bins in the initial or new histogram are scaled for a desired accuracy.

3. The method of claim 1, wherein, from the initial histogram, percentiles are estimated by interpolation between a bin beginning and a bin end.

4. The method of claim 1, wherein the converting step (b) is performed as data is added to the new histogram.

5. The method of claim 1, wherein the converting step (b) is performed as data is removed from the initial histogram.

6. The method of claim 1, wherein the combined histogram is representative of combined data from the new histogram and the initial histogram.

7. The method of claim 1, wherein, in the combining step (c), for an addition of data, the new histograms is added to the initial histogram.

8. The method of claim 1, wherein, in the combining step (c), for a removal of data, the new histogram is subtracted from the initial histogram.

9. The method of claim 1, wherein the combined histogram is computed by determining a weighted contribution of the new histogram and the initial histogram to the combined histogram.

10. The method of claim 1, further comprising storing the initial, new or combined histograms and calculated values in a database for later retrieval, further update, additional calculation, or presentation to one or more users of the computer.

11. An apparatus for estimation of order-based statistics on slowly changing distributions in data stored on a computer, comprising:
a computer;
a Modeling Engine Framework, performed by the computer, for:
(a) converting an initial set of data to an initial histogram based representation of the data set's distribution;
(b) converting new or removed data into a new histogram separate from the initial histogram;
(c) combining the new histogram with the initial histogram to build a combined histogram; and
(d) estimating percentiles and order-based statistics from the combined histogram to provide analysis of a combination of the initial set of data combined with the new or removed data.

12. The apparatus of claim 11, wherein, from the initial histogram, percentiles are estimated by interpolation between a bin beginning and a bin end.

13. The apparatus of claim 11, wherein the Modeling Engine Framework for (b) converting is performed as data is added to the new histogram.

14. The apparatus of claim 11, wherein the Modeling Engine Framework for (b) converting is performed as data is removed from the initial histogram.

15. The apparatus of claim 11, wherein the combined histogram is representative of combined data from the new histogram and the initial histogram.

16. The apparatus of claim 11, wherein, in the Modeling Engine Framework for (c) combining, for an addition of data, the new histograms is added to the initial histogram.

17. The apparatus of claim 11, wherein, in the Modeling Engine Framework for (c) combining, for a removal of data, the new histogram is subtracted from the initial histogram.

18. The apparatus of claim 11, wherein the combined histogram is computed by determining a weighted contribution of the new histogram and the initial histogram to the combined histogram.

19. The apparatus of claim 11, further comprising the Modeling Engine Framework for storing the initial, new or combined histograms and calculated values in a database for later retrieval, further update, additional calculation, or presentation to one or more users of the computer.

20. An article of manufacture comprising a storage device embodying instructions that, when read and executed by a computer, result in the computer performing a method for estimation of order-based statistics on slowly changing distributions in data stored on the computer, comprising:
(a) converting, in the computer, an initial set of data to an initial histogram based representation of the data set's distribution;
(b) converting, in the computer, new or removed data into a new histogram separate from the initial histogram;
(c) combining, in the computer, the new histogram with the initial histogram to build a combined histogram; and
(d) estimating, in the computer, percentiles and order-based statistics from the combined histogram to provide analysis of a combination of the initial set of data combined with the new or removed data.

21. The article of claim 20, wherein, from the initial histogram, percentiles are estimated by interpolation between a bin beginning and a bin end.

22. The article of claim 20, wherein the converting step (b) is performed as data is added to the new histogram.

23. The article of claim 20, wherein the converting step (b) is performed as data is removed from the initial histogram.

24. The article of claim 20, wherein the combined histogram is representative of combined data from the new histogram and the initial histogram.

25. The article of claim 20, wherein, in the combining step (c), for an addition of data, the new histograms is added to the initial histogram.

26. The article of claim 20, wherein, in the combining step (c), for a removal of data, the new histogram is subtracted from the initial histogram.

27. The article of claim 20, wherein the combined histogram is computed by determining a weighted contribution of the new histogram and the initial histogram to the combined histogram.

28. The article of claim 20, further comprising storing the initial, new or combined histograms and calculated values in a database for later retrieval, further update, additional calculation, or presentation to one or more users of the computer.
